(19) United States
(12) Patent Application Publication
(10) Pub. No.: US 2024/0277057 A1
(43) Pub. Date: Aug. 22, 2024

(54) HEATING STRUCTURE AND AEROSOL GENERATING DEVICE INCLUDING THE SAME

(71) Applicant: KT&G CORPORATION, Daejion (KR)

(72) Inventors: Wonkyeong LEE, Guri-si (KR); Paul Joon SUNWOO, Seoul (KR); Moon Sang LEE, Seoul (KR)

(73) Assignee: KT&G CORPORATION, Daejion (KR)

(21) Appl. No.: 18/567,627

(22) PCT Filed: May 11, 2023
(86) PCT No.: PCT/KR2023/006425

§ 371 Date: Dec. 6, 2023

(30) Foreign Application Priority Data
May 18, 2022 (KR) 10 2022-0060817

(51) Int. Cl. A24F 40/465; A24F 40/50

(52) U.S. Cl. CPC A24F 40/465; A24F 40/50

(57) ABSTRACT

A heating structure configured to generate heat using surface plasmon resonance (SPR) includes a substrate, and a metal prism configured to form at least one hole in the substrate and generate heat by SPR.

### TECHNICAL FIELD

The disclosure relates to a heating structure configured to generate heat by surface plasmon resonance (SPR), for example, an aerosol generating device including the heating structure.

### BACKGROUND ART

Techniques for heating a target by generating heat are being developed. For example, heat may be generated by supplying electrical energy to an electrically resistive clement. As another example, heat may be generated by electromagnetic coupling between a coil and a susceptor. The above description is information the inventor(s) acquired during the course of conceiving the present disclosure, or already possessed at the time, and is not necessarily art publicly known before the present application was filed.

### DISCLOSURE OF INVENTION

### Technical Problem

One aspect of the disclosure may provide a heating structure for generating heat using surface plasmon resonance (SPR) and an aerosol generating device including the same.

### Solution to Problem

A heating structure includes a substrate, and a metal prism configured to form at least one hole in the substrate and generate heat by surface plasmon resonance (SPR).

The at least one hole may be surrounded by the substrate and the metal prism.

The metal prism may form a plurality of holes separated from each other.

The at least one hole may have a substantially circular or elliptical shape.

The at least one hole may have a diameter of about 290 nanometers (nm) to about 360 nm.

The first metal prism may include a first base surface facing the substrate, a second base surface opposite to the first base surface, and a plurality of side surfaces between the first base surface and the second base surface to define the at least one hole.

A distance between the first base surface and the second base surface may range from greater than 0 nm to less than or equal to about 10 nm.

The metal prism may include metal particles configured to resonate with light having a wavelength ranging from about 380 nm to about 780 nm.

The substrate may have a thermal conductivity ranging from greater than 0 watts per meter-Kelvin (W/mK) to less than or equal to about 45 W/mK.

An aerosol generating device includes a light source, and a heating structure configured to receive light from the light source, wherein the heating structure may include a substrate, and a metal prism configured to form at least one hole in the substrate and generate heat by SPR.

A heating structure includes a substrate having a thermal conductivity ranging from greater than 0 W/mK to less than or equal to about 45 W/mK, and a metal prism disposed on the substrate and configured to generate heat by SPR.

The substrate may include glass.

A method of manufacturing a heating structure for generating heat by SPR includes applying a plurality of beads on a substrate, reducing a size of the plurality of beads, depositing a plurality of metal particles on the substrate and/or the plurality of beads, and removing the plurality of beads.

The reducing of the size of the plurality of beads may include etching the plurality of beads using reactive ion etching (RIE).

The reducing of the size of the plurality of beads may include reducing a diameter of the beads to range from about 290 nm to about 360 nm.

### Advantageous Effects of Invention

According to an embodiment. when a heating structure is applied to heat target(s), a target may be locally heated, or at least a portion of target(s) among a plurality of targets may be heated. According to an embodiment, a target may be heated in a predetermined temperature range with relatively low energy. In other words, the thermal efficiency of a heating structure may be improved. The effects of the heating structure and the aerosol generating device including the same according to an embodiment may not be limited to the above-mentioned effects, and other unmentioned effects may be clearly understood from the following description by one of ordinary skill in the art.

### BRIEF DESCRIPTION OF DRAWINGS

The foregoing and other aspects, features, and advantages of embodiments in the disclosure will become apparent from the following detailed description with reference to the accompanying drawings.

FIGS. 1 to 3 are diagrams illustrating examples of an aerosol generating article inserted into an aerosol generating device according to an embodiment.

FIGS. 4 and 5 are diagrams illustrating examples of an aerosol generating article according to an embodiment.

FIG. 6 is a block diagram of an aerosol generating device according to an embodiment.

FIGS. 7 to 11 are views illustrating operations of a method of manufacturing a heating structure according to an embodiment.

FIG. 12 is a plan view of a portion of a heating structure according to an embodiment.

FIG. 13 is a cross-sectional view of the heating structure viewed along a line 13-13 of FIG. 12 according to an embodiment.

FIG. 14 illustrates graphs for a comparison of average absorbances of heating structures according to an embodiment.

FIG. 15 illustrates graphs for a comparison of average absorbances of heating structures according to an embodiment.

FIG. 16 is a view illustrating a heating structure according to an embodiment.

FIG. 17 is a graph for a comparison of temperature rises of heating structures according to an embodiment.

FIG. 18 is a graph for a comparison of temperature rises of heating structures according to an embodiment.

FIG. 19 is a diagram illustrating an aerosol generating device according to an embodiment.

### MODE FOR THE INVENTION

The terms used in the embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

Hereinbelow, embodiments of the disclosure will be described in detail with reference to the accompanying drawings so that the embodiments may be readily implemented by one of ordinary skill in the technical field to which the disclosure pertains. However, the present invention may be implemented in many different forms and is not limited to the embodiments described herein.

Hereinafter, embodiments of the disclosure will be described in detail with reference to the drawings.

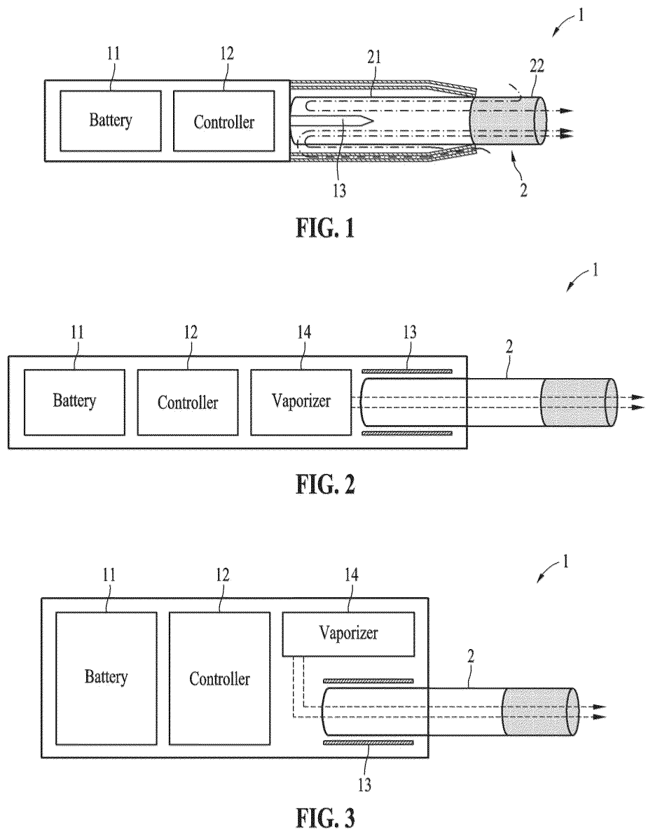

FIGS. 1 to 3 are diagrams illustrating examples of an aerosol generating article inserted into an aerosol generating device.

Referring to FIG. 1, an aerosol generating device 1 may include a battery 11, a controller 12, and a heater 13. Referring to FIGS. 2 and 3, the aerosol generating device 1 may further include a vaporizer 14. In addition, an aerosol generating article 2 (e.g., a cigarette) may be inserted into an inner space of the aerosol generating device 1.

The aerosol generating device 1 shown in FIGS. 1 to 3 may include components related to an embodiment described herein. Therefore, it is to be understood by one of ordinary skill in the art to which the disclosure pertains that the aerosol generating device 1 may further include other general-purpose components in addition to the ones shown in FIGS. 1 to 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, the internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into the user.

Even when the aerosol generating article 2 is not inserted in the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The at least one processor may be implemented as an array of a plurality of logic gates, or may be implemented as a combination of a general-purpose microprocessor and a memory in which a program executable by the microprocessor is stored. In addition, it is to be understood by those having ordinary skill in the art to which the disclosure pertains that the at least one processor may be implemented in other types of hardware.

The heater 13 may be heated by the power supplied by the battery 11. For example, when an aerosol generating article is inserted in the aerosol generating device 1, the heater 13 may be disposed outside the aerosol generating article. The heated heater 13 may thus raise the temperature of an aerosol generating material in the aerosol generating article.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

For another example, the heater 13 may be an induction heater. Specifically, the heater 13 may include an electrically conductive coil for heating the aerosol generating article in an induction heating manner, and the aerosol generating article may include a susceptor to be heated by the induction heater.

For example, the heater 13 may include a tubular heating clement, a plate-shaped heating clement, a needle-shaped heating element, or a rod-shaped heating element, and may heat the inside or outside of the aerosol generating article 2 according to the shape of a heating element.

In addition, the heater 13 may be provided as a plurality of heaters in the aerosol generating device 1. In this case, the plurality of heaters 13 may be disposed to be inserted into the aerosol generating article 2 or may be disposed outside the aerosol generating article 2. In addition, some of the plurality of heaters 13 may be disposed to be inserted into the aerosol generating article 2, and the rest may be disposed outside the aerosol generating article 2. However, the shape of the heater 13 is not limited to what is shown in FIGS. 1 through 3 but may be provided in various shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path may be configured such that the aerosol generated by the vaporizer 14 may pass through the aerosol generating article into the user.

For example, the vaporizer 14 may include a liquid storage (e.g., a reservoir), a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavor ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E. However, embodiments are not limited thereto. The liquid composition may also include an aerosol former such as glycerin and propylene glycol.

The liquid transfer means may transfer the liquid composition in the liquid storage to the heating structure. The liquid transfer means may be, for example, a wick such as cotton fiber, ceramic fiber, glass fiber, or porous ceramic. However, embodiments are not limited thereto.

The heating clement may be an element configured to heat the liquid composition transferred by the liquid transfer means. The heating clement may be, for example, a metal heating wire, a metal heating plate, a ceramic heater, or the like. However, embodiments are not limited thereto. In addition, the heating clement may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

Meanwhile, the aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, an aerosol generating article insertion detection sensor, etc.). In addition, the aerosol generating device 1 may be manufactured to have a structure allowing external air to be introduced or internal gas to flow out even while the aerosol generating article 2 is inserted.

Although not shown in FIGS. 1 to 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The aerosol generating article 2 may be similar to a conventional combustible cigarette. For example, the aerosol generating article 2 may be divided into a first portion including an aerosol generating material and a second portion including a filter or the like. Alternatively, the second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely into the aerosol generating device 1 and the second portion may be partially inserted into the aerosol generating device 1. The user may inhale the aerosol with the second portion in their mouth. In this case, the aerosol may be generated as external air passes through the first portion, and the generated aerosol may pass through the second portion into the mouth of the user.

For example, the external air may be introduced through at least one air path formed in the aerosol generating device 1. In this example, the opening or closing and/or the size of the air path formed in the aerosol generating device 1 may be adjusted by the user. Accordingly, an amount of atomization, a sense of smoking, or the like may be adjusted by the user. As another example, the external air may be introduced into the inside of the aerosol generating article 2 through at least one hole formed on a surface of the aerosol generating article 2.

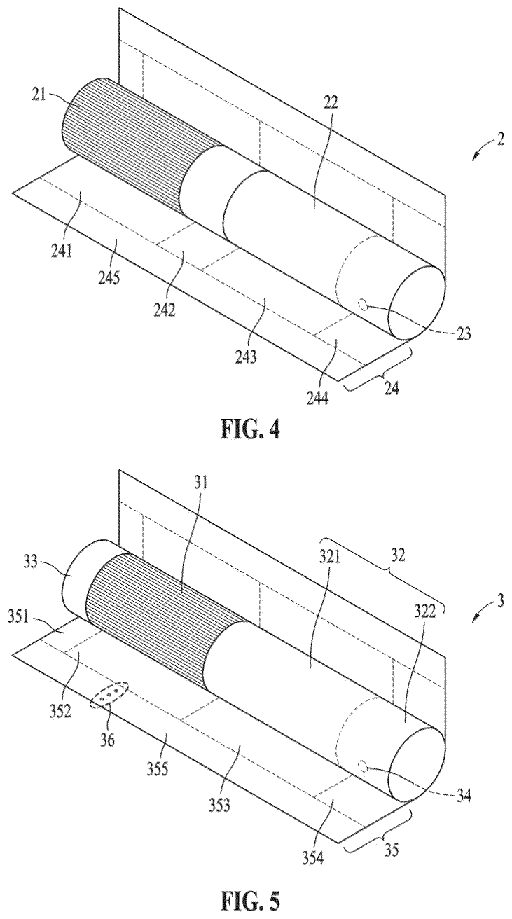

Hereinafter, examples of the aerosol generating article 2 will be described with reference to FIGS. 4 and 5.

FIGS. 4 and 5 are diagrams illustrating examples of an aerosol generating article.

Referring to FIG. 4, the aerosol generating article 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, alternatively, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

The diameter of the aerosol generating article 2 may be in a range of 5 mm to 9 mm. and the length thereof may be about 48 mm. However, embodiments are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas flows out. As an example, the aerosol generating article 2 may be wrapped with one wrapper 24. As another example, the aerosol generating article 2 may be wrapped with two or more of wrappers 24 in an overlapping manner. For example, the tobacco rod 21 may be wrapped with a first wrapper 241, and the filter rod 22 may be wrapped with wrappers 242, 243, and 244. In addition, the aerosol generating article 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, the basis weight of the third wrapper 243 may be in a range of 88 g/m² to 96 g/m², and may be desirably in a range of 90 g/m²to 94 g/m². In addition, the thickness of the third wrapper 243 may be in a range of 120 μm to 130 μm, and may be desirably about 125 μm.

The fourth wrapper 244 may be formed of oilproof hard wrapping paper. For example, the basis weight of the fourth wrapper 244 may be in a range of 88 g/m² to 96 g/m², and may be desirably in a range of 90 g/m² to 94 g/m². In addition, the thickness of the fourth wrapper 244 may be in a range of 120 μm to 130 μm, and may be desirably about 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 245 may be in a range of 57 g/m² to 6.3 g/m², and may be desirably 60 g/m². In addition, the thickness of the fifth wrapper 245 may be in a range of 64 μm to 70 μm, and may be desirably about 67 μm.

The fifth wrapper 245 may have a predetermined material internally added thereto. The material may be, for example, silicon. However, embodiments are not limited thereto. Silicon may have properties, such as, for example, heat resistance which is characterized by less change by temperature. oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the heater 13. Specifically, when the temperature rises above the ignition point of any one of the materials included in the tobacco rod 21, the aerosol generating article 2 may burn. Even in this case, it may still be possible to prevent the aerosol generating article 2 from burning because the fifth wrapper 245 includes a non-combustible material.

In addition, the fifth wrapper 245 may prevent a holder from being contaminated by substances produced in the aerosol generating article 2. Liquid substances may be produced in the aerosol generating article 2 when a user puffs. For example, as an aerosol generated in the aerosol generating article 2 is cooled by external air, such liquid substances (e.g., moisture, etc.) may be produced. As the aerosol generating article 2 is wrapped with the fifth wrapper 245, the liquid substances generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, a metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

The length or diameter of the second segment may be determined in various ways according to the shape of the aerosol generating article 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. As another example, the second segment may be manufactured by weaving a separate fiber to which a flavoring liquid is applied and the fiber formed of the polymer together. As still another example, the second segment may be formed with a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA,) and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. In addition, the total surface area of the second segment may be between about 300 mm²/mm and about 1000 mm²/mm. Further, an aerosol cooling element may be formed from a material having a specific surface area between about 10 mm²/mg and about 100 mm²/mg.

Meanwhile, the second segment may include a thread containing a volatile flavor ingredient. The volatile flavor ingredient may be menthol. However, embodiments are not limited thereto. For example, the thread may be filled with a sufficient amount of menthol to provide at least 1.5 mg of menthol to the second segment.

A third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring clement is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, an aerosol generating article 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and the total length of the aerosol generating article 3 may correspond to the diameter and the total length of the aerosol generating article 2 of FIG. 4. For example, the length of the front end plug 33 may be about 7 mm, the length of the tobacco rod 31 may be about 15 mm, the length of the first segment 321 may be about 12 mm, and the length of the second segment 322 may be about 14 mm. However, embodiments are not limited thereto.

The aerosol generating article 3 may be wrapped by at least one wrapper 35. The wrapper 35 may have at least one hole through which external air flows inside or internal gas flows outside. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

In addition, at least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and a metal foil such as aluminum foil. For example, the total thickness of the first wrapper 351 may be in a range of 45 μm to 55 μm, and may be desirably about 50.3 μm. Further, the thickness of the metal foil of the first wrapper 351 may be in a range of 6 μm to 7 μm, and may be desirably 6.3 μm. In addition, the basis weight of the first wrapper 351 may be in a range of 50 g/m² to 55 g/m², and may be desirably 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, the thickness of the second wrapper 352 may be in a range of 70 μm to 80 μm, and may be desirably about 78 μm. In addition. the basis weight of the second wrapper 352 may be in a range of 20 g/m² to 25 g/m², and may be desirably 23.5 g/m².

For example, the porosity of the third wrapper 353 may be 24000 CU. However, embodiments are not limited thereto. Further, the thickness of the third wrapper 353 may be in a range of 60 μm to 70 μm, and may be desirably about 68 μm. In addition, the basis weight of the third wrapper 353 may be in a range of 20 g/m² to 25 g/m², and may be desirably 21 g/m².

The fourth wrapper 354 may be formed with polylactic acid (PLA) laminated paper. Here, the PLA laminated paper may refer to three-ply paper including a paper layer, a PLA layer, and a paper layer. For example, the thickness of the fourth wrapper 354 may be in a range of 100 μm to 120 μm, and may be desirably about 110 μm. In addition, the basis weight of the fourth wrapper 354 may be in a range of 80 g/m² to 100 g/m², and may be desirably 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 355 may be in a range of 57 g/m² to 6.3 g/m², and may be desirably about 60 g/m². Further, the thickness of the fifth wrapper 355 may be in a range of 64 μm to 70 μm, and may be desirably about 67 μm.

The fifth wrapper 355 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. The mono denier of a filament of the cellulose acetate tow may be in a range of 1.0 to 10.0, and may be desirably in a range of 4.0 to 6.0. The mono denier of the filament of the front end plug 33 may be more desirably about 5.0. In addition, a cross section of the filament of the front end plug 33 may be Y-shaped. The total denier of the front end plug 33 may be in a range of 20000 to 30000, and may be desirably in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, the mono denier and the total denier of the first segment 321 may be the same as the mono denier and the total denier of the front end plug 33.

The second segment 322 may be formed of cellulose acetate. The mono denier of a filament of the second segment 322 may be in a range of 1.0 to 10.0, and may be desirably in a range of 8.0 to 10.0. The mono denier of the filament of the second segment 322 may be more desirably 9.0. In addition, a cross section of the filament of the second segment 322 may be Y-shaped. The total denier of the second segment 322 may be in a range of 20000 to 30000, and may be desirably 25000.

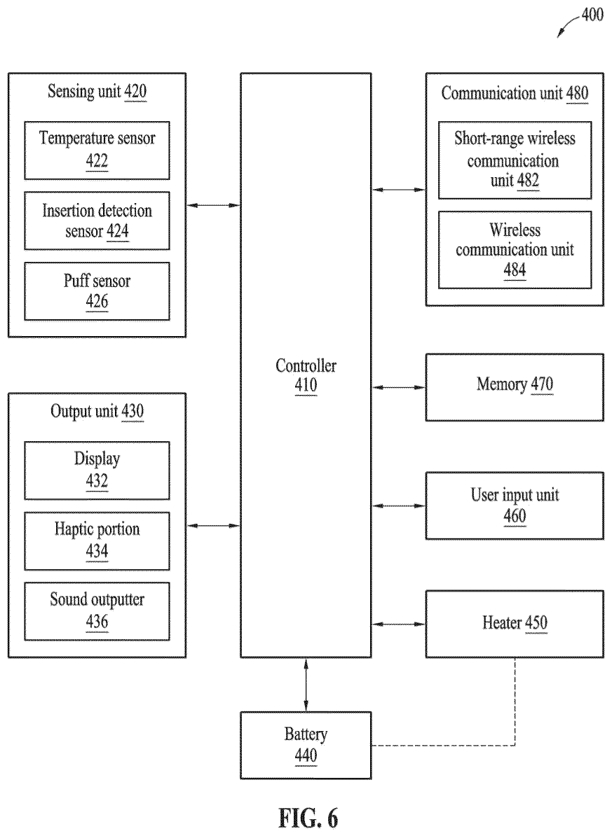

FIG. 6 is a block diagram of an aerosol generating device 400 according to an embodiment.

The aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 426 may sense a puff from a user based on various physical changes in an airflow path or airflow channel. For example, the puff sensor 426 may sense the puff of the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 through 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, that converts power of the battery 440 and supplies the power to respective components.

In an embodiment, the heater 450 may be formed of any suitable electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating element, or the like, but is not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating an aerosol generating article and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed thereby. The memory 470 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communicator, an Internet communicator, a computer network (e.g., a local area network (LAN) or a wide-area network (WAN)) communicator, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The at least one processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

The controller 410 may control the temperature of the heater 450 by controlling the supply of power from the battery 440 to the heater 450. For example, the controller 410 may control the supply of power by controlling the switching of a switching element between the battery 440 and the heater 450. In another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puff's counted through the puff sensor 426 reaches a preset number, the controller 410 may inform the user that the aerosol generating device 400 is to be ended soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

One embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

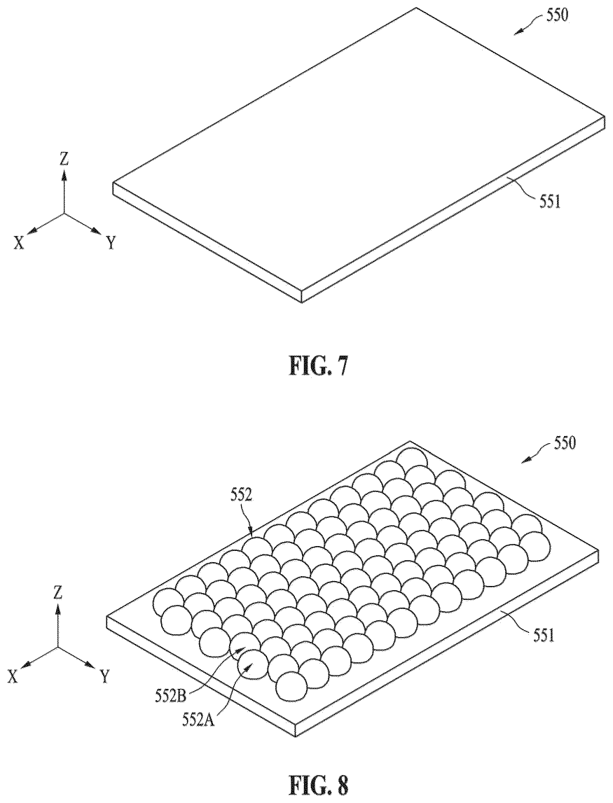

FIGS. 7 to 11 are views illustrating operations of a method of manufacturing a heating structure according to an embodiment. The order of operations of manufacturing the heating structure is not limited to the order described herein, and at least one additional operation may be included between operations, any one of the described operations may be omitted, or the order of some operations may be changed.

Referring to FIG. 7, a method of manufacturing a heating structure 550 may include an operation of providing a substrate 551. The substrate 551 may have a shape of a plate having opposite surfaces (e.g., a surface oriented in a +Z direction and a surface oriented in a −Z direction). At least one surface (e.g., the surface oriented in the +Z direction) of the substrate 551 may be formed as a substantially flat surface.

In an embodiment, the substrate 551 may be formed of various materials. For example, the substrate 551 may be formed of glass, silicon (Si), silicon oxide (SiO₂), sapphire, polystyrene, polymethyl methacrylate, and/or any other material suitable for thermal conduction. In some embodiments, the substrate 551 may be formed of any one or combination of glass, silicon (Si), silicon oxide (SiO₂), and sapphire. In some embodiments, the substrate 551 may include a material having a relatively low heat transfer coefficient. This may allow heat to be locally transferred to a partial area on the substrate 551.

In an embodiment, the substrate 551 may exhibit electrical conductivity. In an embodiment, the substrate 551 may exhibit electrical insulating properties.

In an embodiment, the substrate 551 may be formed of a material having any thermal conductivity suitable for use in an environment in which the heating structure 550 is disposed. For example, the substrate 551 may have a thermal conductivity of about 0.6 Watts per meter-Kelvin (W/mK) or less, about 1 W/mK to about 2 W/mK, about 2 W/mK to about 5 W/mK, about 5 W/mK to about 10 W/mK, about 10 W/mK to about 100 W/mK, or about 100 W/mK to about 200 W/mK, at a pressure of 1 bar and a temperature of 25° C.

In an embodiment, the substrate 551 may have a relative thermal conductivity. In other words, the thermal conductivity of the substrate 551 may be substantially equal to or smaller than the thermal conductivity of another component (e.g., a metal prism 554) of the heating structure 550. When the substrate 551 has a relatively low thermal conductivity, heat dissipation through the substrate 551 may decrease, and the amount of heat transferred to a target may increase. For example, the substrate 551 may have a thermal conductivity of about 45 W/mK or less, about 40 W/mK or less, about 35 W/mK or less, about 30 W/mK or less, about 25 W/mK or less, about 20 W/mK or less, about 15 W/mK or less, about 10 W/mK or less, about 5 W/mK or less, about 2 W/mK or less, or about 1 W/mK, at a pressure of 1 bar and a temperature of 25° C.

Referring to FIG. 8, the method of manufacturing the heating structure 550 may include an operation of applying a plurality of beads 552 on one surface (e.g., the surface oriented in the +Z direction) of the substrate 551. The plurality of beads 552 may be patterned as a monolayer (i.e., substantially a single layer) on the one surface of the substrate 551.

In an embodiment, the plurality of beads 552 may be deposited on the substrate 551 in any suitable method. For example, the plurality of beads 552 may be deposited by physical vapor deposition, chemical vapor deposition, atomic layer deposition, and/or any other suitable method. In some embodiments, the plurality of beads 552 may be deposited by physical vapor deposition.

In an embodiment, the plurality of beads 552 may be applied at a substantially low heat resistance temperature. For example, the plurality of beads 552 may be applied at a heat resistance temperature of about 110° C. or less, about 100° C. or less, about 90° C. or less, about 80° C. or less, about 70° C. or less, about 60° C. or less, about 50° C. or less, about 40° C. or less, or about 30° C. or less. For example, the plurality of beads 552 may be applied at a heat resistance temperature of about 20° C. or higher, about 30° C. or higher, about 40° C. or higher, about 50° C. or higher, about 60° C. or higher, about 70° C. or higher, or about 80° C. or higher. As an example, the plurality of beads 552 may be applied at a heat resistance temperature close to room temperature (about 25° C.).

In an embodiment, the plurality of beads 552 may have a structure having a substantially curved surface. For example, the plurality of beads 552 may each be formed as a sphere having a circular or elliptical cross-section. In an embodiment, the plurality of beads 552 may be formed as a three-dimensional shape having a polygonal cross-section.

In an embodiment, some beads 552 of the plurality of beads 552 may be arranged in contact with each other. In an embodiment, the plurality of beads 552 may be arranged while forming an area between some (e.g., three) adjacent beads 552.

In an embodiment, the plurality of beads 552 may be applied on the substrate 551 in a regular arrangement. For example, the plurality of beads 552 may include a plurality of first beads 552A arranged in a first direction (e.g., +/−X direction) of the substrate 551, and a plurality of second beads 552B positioned in a second direction (e.g., +/−Y direction) intersecting with the first direction of the substrate 551 from the plurality of first beads 552A and arranged in the first direction of the substrate 551. In some embodiments, the plurality of first beads 552A and the plurality of second beads 552B may be arranged such that the center of the plurality of first beads 552A and the center of the plurality of second beads 552B may not match when the substrate 551 is viewed in one direction (e.g., +/−Y direction).

In an embodiment, the plurality of beads 552 may be formed of a styrene-based resin, a (meth)acrylic-based resin, an imide-based resin, and/or a copolymer thereof. In some embodiments, the plurality of beads 552 may be formed of polymethyl methacrylate, polyethyl methacrylate, poly n-butyl methacrylate, polysec-butyl methacrylate, polytert-butyl methacrylate, polymethyl acrylate, polyisopropyl acrylate, polycy-clohexyl methacrylate, poly 2-methylcyclohexyl methacrylate, polydicyclopentanyloxyethyl methacrylate, polyisobornyl methacrylate, polycyclohexylacrylate, poly 2-methylcyclohexyl acrylate, polydicyclopentenyl acrylate, polydicyclopentanyl acrylate, polydicyclopentenyl methacrylate, polydicyclopentanyl methacrylate, polydicyclopentanyloxyethyl acrylate, polyisobornyl acrylate, polyphenylmethacrylate, polyphenylacrylate, polybenzyl acrylate, polybenzyl methacrylate, poly 2-hydroxyethyl methacrylate, polystyrene, polyα-methylstyrene, polym-methylstyrene, polyp-methylstyrene, vinyltoluene, 1,3-butadiene, isoprene, 2,3-dimethyl 1,3-butadiene, polyimide, and/or a combination thereof. In some embodiments, the plurality of beads 552 may be formed of polystyrene or silica. In some embodiments, the plurality of beads 552 may be formed of polystyrene.

In an embodiment, the plurality of beads 552 may have an average maximum diameter of about 10 nm or greater, about 50 nm or greater, about 90 nm or greater, about 100 nm or greater, about 150 nm or greater, about 200 nm or greater, about 300 nm or greater, about 450 nm or greater, or about 500 nm or greater. In some embodiments, the plurality of beads 552 may have an average maximum diameter of about 450 nm or greater.

In an embodiment, the plurality of beads 552 may have an average maximum diameter of about 1,000 nm or less, about 900 nm or less, about 800 nm or less, about 700 nm or less, about 600 nm or less, or about 550 nm or less. In some embodiments, the plurality of beads 552 may have an average maximum diameter of about 600 nm or less.

Referring to FIG. 9, the method of manufacturing the heating structure 550 may include an operation of reducing the size of the plurality of beads 552 on the substrate 551.

In an embodiment, the reduced size (e.g., average maximum diameter) of the plurality of beads 552 may be about 360 nm or less, about 350 nm or less, about 340 nm or less, about 330 nm or less, about 320 nm or less, about 310 nm or less, or about 300 nm or less. In an embodiment, the reduced size (e.g., average maximum diameter) of the plurality of beads 552 may be about 290 nm or greater, about 300 nm or greater, about 310 nm or greater, about 320 nm or greater, about 330 nm or greater, or about 340 nm or greater.

In an embodiment, the plurality of beads 552 may have substantially the same shape as the shape before their size is reduced. For example, the plurality of beads 552 may be maintained as a sphere having a circular or elliptical cross-section.

In an embodiment, the size of the plurality of beads 552 may be reduced by any suitable method. In an embodiment, the size of the plurality of beads 552 may be reduced by an etching process (e.g., reactive ion etching (RIE), ion milling, and/or any other etching). RIE may be selected as one advantageous process given that free electrons of metal particles are concentrated in an edge area of a metal prism (e.g., the metal prism 554). In an embodiment, the size of the plurality of beads 552 may be reduced by at least partially immersing the plurality of beads 552 in a solvent.

In an embodiment, at least a portion of beads 552 among the plurality of beads 552 having the reduced size may be physically separated from each other. The portion of beads 552 among the plurality of beads 552 may be offset without contacting each other to form a gap therebetween.

Referring to FIG. 10, the method of manufacturing the heating structure 550 may include an operation of depositing the plurality of metal particles 553 on the one surface (e.g., the surface oriented in the +Z direction) of the substrate 551.

In an embodiment, the plurality of metal particles 553 may be nanoscale. For example, the plurality of metal particles 553 may have an average maximum diameter of about 1 μm or less. In some embodiments, the plurality of metal particles 553 may have an average maximum diameter of about 700 nm or less, about 600 nm or less, about 500 nm or less, about 400 nm or less, about 300 nm or less, about 200 nm or less, about 150 nm or less, or about 100 nm or less.

In an embodiment, the plurality of metal particles 553 may be deposited on the substrate 551 and/or the plurality of beads 552 by any suitable deposition method. For example, the plurality of metal particles 553 may be deposited by sputtering, ion beam deposition, thermal evaporation, chemical vapor deposition, plasma deposition, and/or any other suitable deposition method.

In an embodiment, the plurality of metal particles 553 may be deposited on a first deposition area A1 including respective exposed areas of the plurality of beads 552 positioned on one surface of the substrate 551, and a second deposition area A2 including an area of at least a portion of the one surface of the substrate 551 and/or areas between the plurality of beads 552. In some embodiments, the substrate 551 may include a non-deposition area A3 where the plurality of metal particles 553 are not deposited and the plurality of beads 552 are not positioned.

In an embodiment, the plurality of metal particles 553 may be formed of any material suitable for generating heat. For example, the plurality of metal particles 553 may include at least one of gold, silver, copper, palladium, platinum, aluminum, titanium, nickel, chromium, iron, cobalt, manganese, rhodium, and ruthenium, or a combination thereof.

In an embodiment, the plurality of metal particles 553 may be formed of any material suitable for generating heat by interacting with light of a determined wavelength band (e.g., a visible light wavelength band, that is, about 380 nm to about 780 nm). For example, the plurality of metal particles 553 may include at least one of gold, silver, copper, palladium, and platinum, or a combination thereof.

In some embodiments, the plurality of metal particles 553 may be formed of a metal material having an average maximum absorbance. Here, the average maximum absorbance may be defined as an absorbance substantially having a peak in a wavelength band. A wavelength band corresponding to the absorbance may be understood as a wavelength band in which the plurality of metal particles 553 resonate. For example, the plurality of metal particles 553 may be formed of a metal material having an average maximum absorbance in a wavelength band between about 430 nm and about 450 nm, between about 480 nm and about 500 nm, between about 490 nm and about 510 nm, between about 500 nm and about 520 nm, between about 550 nm and about 570 nm, between about 600 nm and about 620 nm, between about 620 nm and about 640 nm, between about 630 nm and about 650 nm, between about 640 nm and about 660 nm, between about 680 nm and about 700 nm, or between about 700 nm and about 750 nm. The average maximum absorbance of the plurality of metal particles 553 may vary depending on the type of the substrate 551 in addition to the metal material, the size of a structure (e.g., a metal prism) formed by the plurality of metal particles 553, and/or the shape of the structure.

In an embodiment, the deposition thickness of the plurality of metal particles 553 may be about 20 nm or less. In a preferred embodiment, the deposition thickness of the plurality of metal particles 553 may be about 10 nm or less. When the plurality of metal particles 553 are deposited on the substrate 551 in a thickness greater than 10 nm, an exothermic reaction may be reduced in the structure (e.g., the metal prism) formed by the plurality of metal particles 553. When the thickness of the structure formed by the plurality of metal particles 553 exceeds 10 nm, the possibility of heat being lost to the surroundings of the heating structure 550 may increase, and thus, the thermal efficiency of the heating structure 550 may decrease.

Referring to FIG. 11. the method of manufacturing the heating structure 550 may include an operation of removing the plurality of beads (e.g., the beads 552 of FIG. 10). When the plurality of beads are removed, a plurality of holes H surrounded by the metal prism 554 may be formed on the substrate 551. The holes H may have a shape (e.g., a substantially circular or elliptical shape) corresponding to the cross-sectional shape of the beads.

Removing the plurality of beads may be performed by any suitable method. In an embodiment, the plurality of beads may be dissolved by a solvent by being immersed in the solvent. For example, the solvent may include one or more of toluene, acetone, benzene, phenol, ether, and/or any other suitable inorganic solvent or any organic solvent. In an embodiment, the plurality of beads may be removed by an etching process (e.g., reactive ion etching (RIE), ion milling, and/or any other etching).

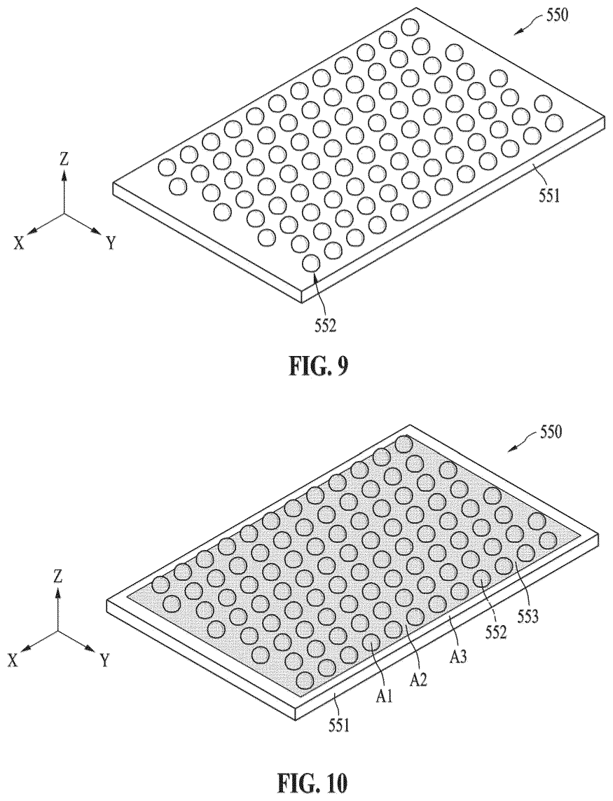

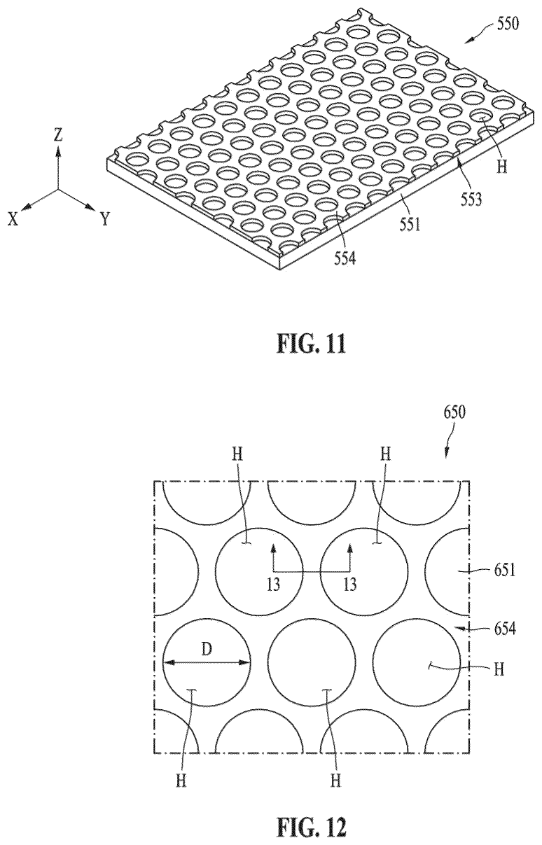

FIG. 12 is a plan view of a portion of a heating structure according to an embodiment, and FIG. 13 is a cross-sectional view of the heating structure viewed along a line 13-13 of FIG. 12 according to an embodiment.

Referring to FIGS. 12 and 13, a heating structure 650 may be configured to generate heat by surface plasmon resonance (SPR). “SPR” refers to the collective oscillation of electrons propagating along an interface of metal particles with a medium. For example, the collective oscillation of electrons of metal particles may be caused by light propagating from the outside of the heating structure 650. The excitation of electrons of metal particles may generate thermal energy, and the generated thermal energy may be transferred within an environment to which the heating structure 650 is applied.

The heating structure 650 may include a substrate 651. The substrate 651 may include a first surface 651A (e.g., a top surface) and a second surface 651B (e.g., a bottom surface) opposite to the first surface 651A.

The heating structure 650 may include a metal prism 654. The metal prism 654 may have a net shape. The metal prism 654 may be substantially a single structure and form a plurality of holes H. The metal prism 654 may include a first base surface 654A facing the first surface 651A of the substrate 651, a second base surface 654B opposite to the first base surface 654A, and a plurality of side surfaces 654C1 and 654C2 between the first base surface 654A and the second base surface 654B. The first surface 651A of the substrate 651 and the plurality of side surfaces 654C1 and 654C2 of the metal prism 654 may define the plurality of holes H.

In an embodiment, the first base surface 654A and the second base surface 654B may be substantially parallel to each other.

In an embodiment, the first base surface 654A and/or the second base surface 654B may be formed as a substantially flat surface.

In an embodiment. the distance between the first base surface 654A and the second base surface 654B (e.g., the thickness of the metal prism 654) may be about 10 nm or less. When the metal prism 654 has a thickness exceeding 10 nm, the exothermic reaction of a plurality of metal particles forming the metal prism 654 may decrease, and consequently, the thermal efficiency of the heating structure 650 may decrease.

In an embodiment, the plurality of side surfaces 654C1 and 654C2 of the metal prism 654 may be oriented in different directions. For example, the first side face 654C1 may be oriented in a first direction (e.g., a first radial direction), and the second side surface 654C2 may be oriented in a second direction (e.g., a second radial direction) substantially opposite to the first direction.

In an embodiment, at least one side surface of the plurality of side surfaces 654C1 and 654C2 may be formed as a substantially curved surface. In some embodiments, the plurality of side surfaces 654C1 and 654C2 may be formed as curved surfaces having substantially the same curvature. In an embodiment, the curvature of any one of the plurality of side surfaces 654C1 and 654C2 may be different from the curvature of another side surface.

In an embodiment, the plurality of side surfaces 654C1 and 654C2 may be formed as curved surfaces that are concave toward the center of the metal prism 654. In an embodiment, at least one side surface of the plurality of side surfaces 654C1 and 654C2 may be formed as a curved surface that is convex from the center of the metal prism 654.

In an embodiment, the metal prism 654 may include two side surfaces. For example, the metal prism 654 may have a substantially semicircular shape or a shape close to a semicircle.

In an embodiment, a portion of holes H among the plurality of holes H may be separated from each other. The portion of holes H may be separated by a portion of the metal prism 654. In some embodiments, the portion of holes H among the plurality of holes H may be connected to each other. For example, a portion of areas of the metal prism 654 may not be connected to each other, and holes H on both sides of the areas may be connected.

In an embodiment, the plurality of holes H may have an average maximum diameter D of about 10 nm or greater, about 50 nm or greater, about 90 nm or greater, about 100 nm or greater, about 150 nm or greater, about 200 nm or greater, about 300 nm or greater, about 350 nm or greater, about 450 nm or greater, or about 500 nm or greater. In some embodiments, the plurality of holes H may have an average maximum diameter D of about 450 nm or greater.

In an embodiment, the plurality of holes H may have an average maximum diameter D of about 1,000 nm or less, about 900 nm or less, about 800 nm or less, about 700 nm or less, about 600 nm or less, or about 550 nm or less. In some embodiments, the plurality of holes H may have an average maximum diameter D of about 600 nm or less.

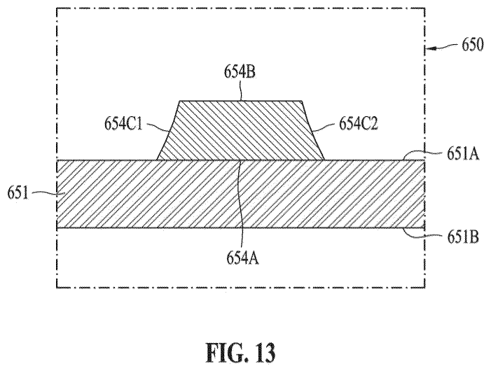

FIG. 14 illustrates graphs for a comparison of average absorbances of heating structures according to an embodiment.

Referring to FIG. 14, a graph on the left shows an absorbance of a heating structure (e.g., the heating structure 650 of FIG. 12) according to a wavelength, wherein the heating structure includes a glass substrate, and a metal prism that includes gold and is formed using polystyrene beads having a diameter of about 460 nm. The resonant wavelength of the heating structure was about 640 nm.

A graph in the middle shows an absorbance of a heating structure (e.g., the heating structure 650 of FIG. 12) according to a wavelength, wherein the heating structure includes a glass substrate, and a metal prism that includes gold and is formed by reducing the size of polystyrene beads having a diameter of about 460 nm using RIE. The resonant wavelength of the heating structure was about 640 nm.

A graph on the right shows an absorbance of a heating structure (e.g., the heating structure 650 of FIG. 12) according to a wavelength, wherein the heating structure includes a glass substrate, and a metal prism that includes gold and is formed using polystyrene beads having a diameter of about 800 nm. The resonant wavelength of the heating structure was about 700 nm.

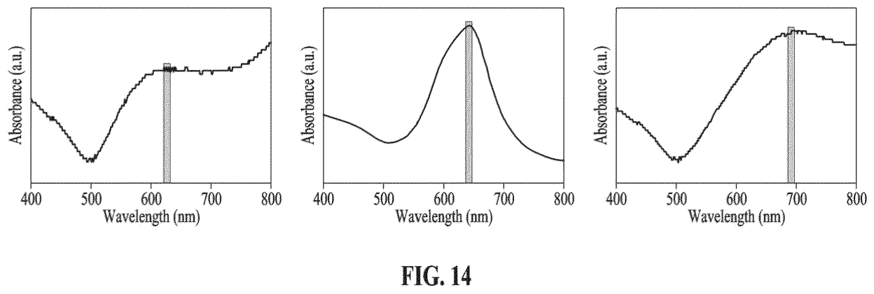

FIG. 15 illustrates graphs for a comparison of average absorbances of heating structures according to an embodiment.

Referring to FIG. 15, a graph on the left shows an absorbance of a heating structure (e.g., the heating structure 650 of FIG. 12) according to a wavelength, wherein the heating structure includes a sapphire substrate, and a metal prism that includes gold and is formed using polystyrene beads having a diameter of about 460 nm. The resonant wavelength of the heating structure was about 640 nm.

A graph in the middle shows an absorbance of a heating structure (e.g., the heating structure 650 of FIG. 12) according to a wavelength, wherein the heating structure includes a sapphire substrate, and a metal prism that includes gold and is formed by reducing the size of polystyrene beads having a diameter of about 460 nm using RIE. The resonant wavelength of the heating structure was about 610 nm and about 680 nm.

A graph on the right shows an absorbance of a heating structure (e.g., the heating structure 650 of FIG. 12) according to a wavelength, wherein the heating structure includes a sapphire substrate, and a metal prism that includes gold and is formed using polystyrene beads having a diameter of about 800 nm. The resonant wavelength of the heating structure did not appear in the visible wavelength band.

Referring to the graphs of FIGS. 14 and 15, it can be learned that the resonant wavelength of a heating structure increases as the size of beads increases.

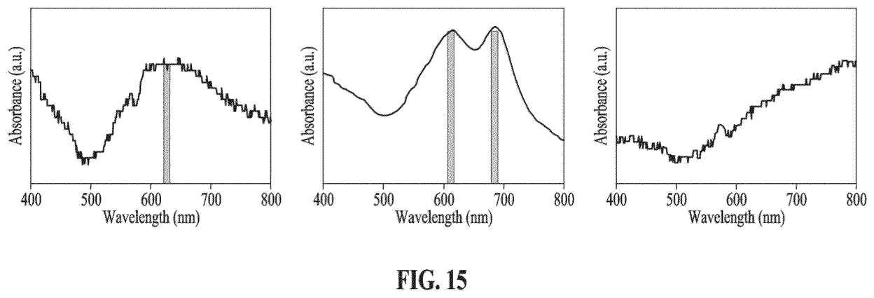

FIG. 16 is a view illustrating a heating structure according to an embodiment.

Referring to FIG. 16, a heating structure 750 may include a substrate 751 including a first surface 751A and a second surface 751B, an SPR structure 754 (e.g., the metal prism 554 or 654) positioned on the first surface 751A, and a reflective layer 755 positioned on the second surface 751B. The heating structure 750 may be configured to receive light L onto the substrate 751 and/or the SPR structure 754.

In an embodiment, the SPR structure 754 may be implemented as at least one metal prism (e.g., the metal prism 554 or 654) including a plurality of metal particles. In an embodiment, the SPR structure 754 may include a plurality of metal particles applied on the first surface 751A of the substrate 751. In an embodiment, the SPR structure 754 may include at least one metal film formed of a metal material.

A light source emitting the light L may be separated from the heating structure 750 by a determined distance. For example, the distance between the light source and the heating structure 750 may be determined to be about 40 cm or less, about 35 cm or less, about 30 cm or less, about 25 cm or less, about 20 cm or less, about 15 cm or less, about 10 cm or less, or about 5 cm or less. The distance between the light source and the heating structure 750 may be determined to be about 5 cm or greater, about 10 cm or greater, about 15 cm or greater, about 20 cm or greater, or about 25 cm or greater.

The light L may form a spot LS on the substrate 751 and/or the SPR structure 754. For example, the spot LS may have a size of about 2 mm or less, about 1.5 mm or less, about 1 mm or less, or about 0.5 mm or less. The spot LS may have a size of about 0.2 mm or greater, about 0.4 mm or greater, about 0.6 mm or greater, or about 0.8 mm or greater.

The reflective layer 755 may be configured to reflect the light L passing through the substrate 751 to the substrate 751 and/or the SPR structures 754. The reflective layer 755 reflecting the light L passing through the substrate 751 may allow the substrate 751 and the SPR structures 754 to use the reflected light, whereby the light use efficiency of the heating structure 750 may increase and the heating efficiency may increase accordingly.

In an embodiment, the reflective layer 755 may be formed on the entire second surface 751B of the substrate 751. In an embodiment, the reflective layer 755 may be formed locally on the second surface 751B of the substrate 751. For example, the reflective layer 755 may be implemented as a single reflective zone in a partial area of the second surface 751B of the substrate 751, or as a plurality of reflective zones.

The reflective layer 755 may be formed of any material suitable for reflecting the light L. In an embodiment, the reflective layer 755 may be formed of a metal material. For example, the reflective layer 755 may be formed of at least one of gold, silver, copper, and any other metal material suitable for reflection, or a combination thereof.

The reflective layer 755 may have any thickness suitable for reflecting the light L. The thickness of the reflective layer 755 may be determined to be a value suitable for substantially total reflection of the light L. For example, the reflective layer 755 may have a thickness of about 15 nm or less, about 12 nm or less, about 10 nm or less, about 8 nm or less, or about 5 nm or less. In a preferred example, the reflective layer 755 may have a thickness of about 10 nm. The thickness of the reflective layer 755 may be determined by the refractive index of the substrate 751, the thickness of the substrate 751, the refractive index of the reflective layer 755, and/or any other parameter.

In an embodiment, the reflective layer 755 may directly contact the second surface 751B of the substrate 751. In an embodiment, the reflective layer 755 may be spaced apart from the second surface 751B of the substrate 751, and a medium (e.g., air) may be positioned between the second surface 751B and the reflective layer 755.

In an embodiment, the heating structure 750 may include an absorbing layer 756 positioned on the reflective layer 755. The absorbing layer 756 may be configured to absorb a portion of transmitted light that is transmitted through the reflective layer 755 without being reflected by the reflective layer 755. The absorbing layer 756 may increase the light use efficiency of the heating structure 750.

In an embodiment, the absorbing layer 756 may be at least partially applied to the reflective layer 755 by coating.

In an embodiment, the absorbing layer 756 may have a substantially high emissivity. In some embodiments, the absorbing layer 756 may have an emissivity substantially close to “1”. The absorbing layer 756 may be implemented as a structure and/or material close to a substantially black body. For example, the absorbing layer 756 may be implemented as a structure having at least one hole through which light may enter and be substantially permanently reflected therein. As another example, the absorbing layer 756 may be implemented as a black colorant. As still another example, the absorbing layer 756 may be implemented as a black matrix. In an embodiment, the absorbing layer 756 may be implemented as a gray body or a white body.

In an embodiment, the absorbing layer 756 may include a material having heat resistance. For example, the absorbent layer 756 may include a material configured to withstand a heat-resistant temperature environment of about 750° C. or higher, about 800° C. or higher, about 850° C. or higher, about 900° C. or higher, about 950° C. or higher, or about 1,000° C. or higher.

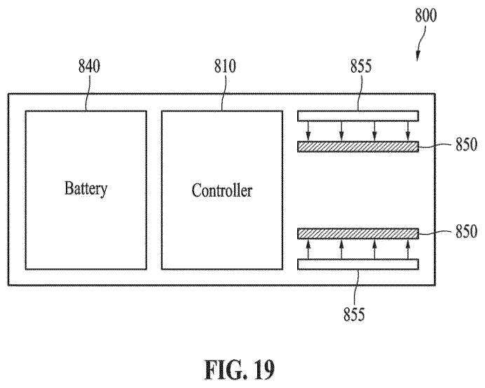

In an embodiment, the heating structure 750 may include a thermal imager 760 configured to generate a thermal image. For example, the thermal imager 760 may generate an image including the thermal distribution of the heating structure 750. In an embodiment, the thermal imager 760 may be included in an external component of the heating structure 750 (e.g., an aerosol generating device 800 of FIG. 19).

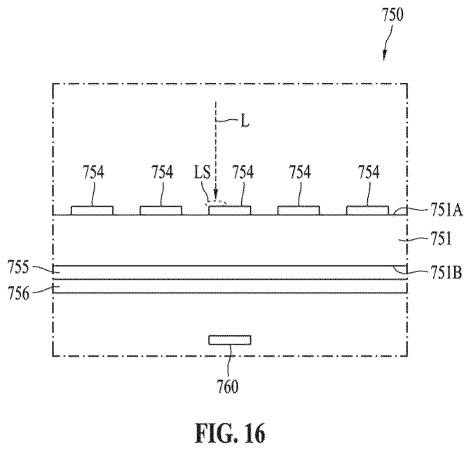

FIG. 17 is a graph for a comparison of temperature rises of heating structures according to an embodiment.

Referring to FIG. 17, a first heating structure H1 included a glass substrate, a metal film that includes gold and has a thickness of 10 nm, and an absorbing layer. The glass substrate has a thermal conductivity of about 0.8 W/mK. A second heating structure H2 included a sapphire substrate, a metal film that includes gold and has a thickness of 10 nm. and an absorbing layer. The sapphire substrate has a thermal conductivity of about 46.06 W/mK. The first heating structure H1 showed a relatively great increase in temperature as the laser output increased, while the second heating structure H2 showed a relatively small increase in temperature as the laser output increased. This indicates that the thermal efficiency of a heating structure may decrease because a substrate having high thermal conductivity absorbs generated heat more.

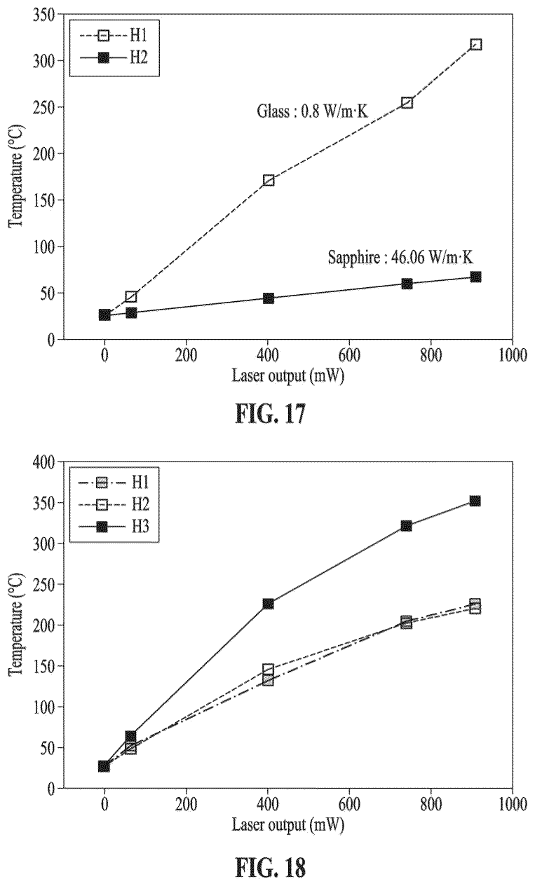

FIG. 18 is a graph for a comparison of temperature rises of heating structures according to an embodiment.

Referring to FIG. 18. a first heating structure H1 was manufactured using polystyrene beads having a diameter of about 460 nm. The size of the polystyrene beads was substantially maintained. After the polystyrene beads were removed, a metal prism of the first heating structure H1 had a structure in which a plurality of metal prisms are spaced apart from each other. The first heating structure H1 included an absorbing layer.

A second heating structure H2 was manufactured using polystyrene beads having a diameter of about 800 nm. The size of the polystyrene beads was substantially maintained. After the polystyrene beads were removed, a metal prism of the second heating structure H2 had a structure in which a plurality of metal prisms arc spaced apart from each other. The second heating structure H2 included an absorbing layer.

A third heating structure H3 was manufactured using polystyrene beads having a diameter of about 460 nm. The size of the polystyrene beads was reduced to about 300 nm using RIE, and then metal particles were deposited and the polystyrene beads were removed. The third heating structure H3 had a metal prism structure implemented as a single structure having a net shape. The third heating structure H3 included an absorbing layer.

The first heating structure H1 and the second heating structure H2 showed similar temperature increase rates according to the laser output. Meanwhile, the third heating structure H3 achieved a higher temperature with respect to the same laser output than the first heating structure H1 and the second heating structure H2. This confirmed that a heating structure including a net-shaped metal prism manufactured by reducing the size of polystyrene beads using RIE may achieve higher thermal efficiency.

FIG. 19 is a diagram illustrating an aerosol generating device according to an embodiment.

Referring to FIG. 19, the aerosol generating device 800 may include at least one heating structure 850 configured to heat an aerosol generating article (e.g., the aerosol generating article 2 or 3). and at least one light source 855 configured to emit light toward the at least one heating structure 850. Meanwhile, although FIG. 19 illustrates the aerosol generating device 800 including a controller 810 configured to control the heating structure 850 and/or the light source 855, and a battery 840 configured to supply electrical energy to the controller 810, other components may also be included or omitted.

In an embodiment, the aerosol generating device 800 may include a single heating structure 850. The heating structure 850 may at least partially surround a cavity in which an aerosol generating article is to be placed. The heating structure 850 may have a structure in which, for example, the substrate 551, 651, or 751 at least partially has a curved surface.

In an embodiment, the aerosol generating device 800 may include a plurality of heating structures 850. The plurality of heating structures 850 may be positioned in different portions based on the cavity in which an aerosol generating article is to be placed. Metal materials of metal prisms included in the plurality of heating structures 850 may be the same or different.

In an embodiment, the light source 855 may be configured to transmit an optical signal toward the heating structure 850 at a determined angle. For example, the light source 855 may transmit an optical signal at an angle that may cause total reflection on the surface of the heating structure 850. In an embodiment, the light source 855 may transmit an optical signal toward the heating structure 850 at any angle.

In an embodiment, the light source 855 may be configured to transmit light in an ultraviolet band, a visible band, and/or an infrared band. In some embodiments, the light source 855 may be configured to transmit light in the visible band (e.g., about 380 nm to about 780 nm).

In some embodiments, the light source 855 may be configured to transmit light in a band corresponding to a material of metal particles of a metal prism included in the heating structure 850. For example, the light source 855 may transmit light in a wavelength band corresponding to an average maximum absorbance according to the material of the metal particles.

In an embodiment, the light source 855 may include a light-emitting diode and/or a laser. The light-emitting diode and/or the laser may be of a type and/or size suitable for being included in the aerosol generating device 800. For example, the laser may include a solid-state laser and/or a semiconductor laser.

In an embodiment, the aerosol generating device 800 may include a plurality of light sources 855. The plurality of light sources 855 may be implemented as light sources of the same type. In an embodiment, at least a portion of the plurality of light sources 855 may be implemented as different types of light sources.

In an embodiment, at least one light source 855 among the plurality of light sources 855 may be configured to irradiate a portion of the heating structure 850.

In an embodiment, a portion of the heating structure 850 irradiated by any one light source 855 of the plurality of light sources 855 may be different from a portion of the heating structure 850 irradiated by another light source 855. For example, the plurality of light sources 855 may irradiate different portions of a single heating structure 850 or irradiate a plurality of heating structures 850.

In an embodiment, the plurality of light sources 855 may be configured to irradiate substantially at the same time. In an embodiment, an irradiation point in time of any one light source 855 of the plurality of light sources 855 may be different from an irradiation point in time of another light source 855.

In an embodiment, the plurality of light sources 855 may irradiate the heating structure 850 for substantially the same time. In an embodiment, an irradiation time of any one light source 855 of the plurality of light sources 855 may be different from an irradiation time of another light source 855.

In an embodiment, the plurality of light sources 855 may transmit light of substantially the same wavelength band. In an embodiment, a band of light irradiated by any one light source 855 of the plurality of light sources 855 may be different from a band of light irradiated by another light source 855.

In an embodiment, the plurality of light sources 855 may irradiate the heating structure 850 with substantially the same illuminance. In an embodiment, an illuminance of any one light source 855 of the plurality of light sources 855 may be different from an illuminance of another light source 855.

The embodiments of the present disclosure are intended to be illustrative and not restrictive. Various modifications may be made to the detailed description of the present disclosure including the accompanying scope of claims and equivalents. Any of the embodiment(s) described herein may be used in combination with any other embodiment(s) described herein.

1. A heating structure, comprising:
a substrate; and
a metal prism configured to form at least one hole in the substrate and generate heat by surface plasmon resonance (SPR).

2. The heating structure of claim 1, wherein
the at least one hole is surrounded by the substrate and the metal prism.

3. The heating structure of claim 1, wherein
the metal prism forms a plurality of holes separated from each other.

4. The heating structure of claim 1, wherein
the at least one hole has a substantially circular or elliptical shape.

5. The heating structure of claim 1, wherein
the at least one hole has a diameter of about 290 nanometers (nm) to about 360 nm.

6. The heating structure of claim 1, wherein
the metal prism comprises a first base surface facing the substrate, a second base surface opposite to the first base surface, and a plurality of side surfaces between the first base surface and the second base surface to define the at least one hole.

7. The heating structure of claim 6, wherein
a distance between the first base surface and the second base surface ranges from greater than 0 nm to less than or equal to about 10 nm.

8. The heating structure of claim 1, wherein
the metal prism comprises metal particles configured to resonate with light having a wavelength ranging from about 380 nm to about 780 nm.

9. The heating structure of claim 1, wherein
the substrate has a thermal conductivity ranging from greater than 0 watts per meter-Kelvin (W/mK) to less than or equal to about 45 W/mK.

10. An aerosol generating device, comprising:
a light source; and
the heating structure according to claim 1, the heating structure configured to receive light from the light source.

11. A heating structure, comprising:
a substrate having a thermal conductivity ranging from greater than 0 watts per meter-Kelvin (W/mK) to less than or equal to about 45 W/mK; and
a metal prism disposed on the substrate and configured to generate heat by surface plasmon resonance (SPR).

12. The heating structure of claim 11, wherein
the substrate comprises glass.

13. A method of manufacturing a heating structure for generating heat by surface plasmon resonance (SPR), the method comprising:
applying a plurality of beads on a substrate;
reducing a size of the plurality of beads;
depositing a plurality of metal particles on the substrate and/or the plurality of beads; and
removing the plurality of beads.

14. The method of claim 13, wherein
the reducing of the size of the plurality of beads comprises etching the plurality of beads using reactive ion etching (RIE).

15. The method of claim 13, wherein
the reducing of the size of the plurality of beads comprises reducing a diameter of the beads to range from about 290 nanometers (nm) to about 360 nm.
